(19) United States
(12) Patent Application Publication
(10) Pub. No.: US 2026/0270168 A1
(43) Pub. Date: Sep. 10, 2026

(54) ANALYTIC REPORT DESIGN FOR COLLABORATIVE CONTROL BETWEEN CORRELATED NETWORK FUNCTIONS

(71) Applicant: Telefonaktiebolaget LM Ericsson (publ), Stockholm (SE)

(72) Inventors: Sabrine AROUA, Antony (FR); Mathieu LECONTE, Verrières-le-Buisson (FR); Maxime BOUTON, Stockholm (SE); Konstantinos VANDIKAS, Solna (SE); Ulf MATTSSON, Kungsbacka (SE)

(73) Assignee: Telefonaktiebolaget LM Ericsson (publ), Stockholm (SE)

(21) Appl. No.: 19/166,390

(22) PCT Filed: May 15, 2023
(86) PCT No.: PCT/EP2023/063022

§ 371 Date: Sep. 17, 2025

(30) Foreign Application Priority Data
Mar. 22, 2023 (GR) 20230100233

(51) Int. Cl. H04L 41/50; H04L 43/062

(52) U.S. Cl. CPC H04L 41/5032; H04L 43/062

(57) ABSTRACT

A network node in a communications network can detect a triggering event associated with a characteristic of the communications network. The network node can further determine a plurality of network functions (“NFS”) based on operation of each NF of the plurality of NFs impacting the characteristic of the communications network. The network node can generate a collaborative analytical report for each NF of the plurality of NFs based on their respective impact on the characteristic of the communications network. The network, node can further transmit the respective collaborative analytical report to each NF of the plurality of NFs.

### TECHNICAL FIELD

The present disclosure is related to wireless communication systems and more particularly to analytic report design for collaborative control between correlated network functions.

### BACKGROUND

FIG. 1 illustrates an example of a new radio (“NR”) network (e.g., a 5th Generation (“5G”) network) including a 5G core (“5GC”) network 130, network nodes 120a-b (e.g., 5G base station (“gNB”)), multiple communication devices 110 (also referred to as user equipment (“UE”).

A Network Data Analytics Function (“NWDAF”) procedure represents an emerging 3^{rd} Generation Partnership Project (“3GPP”) standard. A NWDAF uses network data analytics in the 5G Core to drive network automation and service orchestration. Therefore, a NWDAF communicates with multiple data sources placed in the 5G Core, Cloud, and Edge networks, to aggregate and correlate data. After performing statistical or predictive analytics on collected data and applying Artificial Intelligence (“AI”)/Machine Learning (“ML”) algorithms, a NWDAF provides adequate analytics for diverse Network Functions (“NFs”). NFs present service consumers of the NWDAF. They are subscribed to NWDAF to request analytic reports. Once one NF receives an analytic report/prediction about some future Key Performance Indicators (“KPIs”) it is interested in, it performs some actions on the system. Every NF is interested in specific analytic reports, for example slicing load level, quality of service (“QoS”) sustainability, UE mobility, session management congestion control, and many more. The objective of the interaction between NWDAF and NFs is to enhance the final users' QoS and, therefore, Quality of Experience (“QoE”).

In some systems, multiple NFs that belong to numerous vendors coexist. Generally, some NFs might not be aware of the presence of other NFs. The NWDAF's role can be limited to providing requested analytic reports to NFs. Thereafter, every NF interacts with its surrounding environment with the goal of improving some performance metrics, based on the received report.

Despite the variety and heterogeneity of existing NFs in terms of requested analytic reports and the KPIs to be improved, some NFs are interacting implicitly with each other. One NF's interaction with the sub-system (e.g., the set of KPIs) it is interested in can impact positively or negatively, the KPIs that another NF is interested in. For example, one NF managing the Physical Resource Block (“PRB”) allocation to optimize the traffic load will impact the traffic delay, which might be managed by another NF controlling the traffic scheduling. Generally, NFs are not coordinated. They don't collaborate. However, there exists a great potential to create a robust collaboration between NF to improve their experience in the network. Collaboration between NFs is crucial, especially when one NF is in a critical situation. In some examples, one NF is in a critical situation when it receives an analytic report indicating an urgent degradation in the key performance metrics, it is interested in. In that case, the concerned NF might not be able to tackle this degradation in the network performance with its local capabilities.

### SUMMARY

Certain aspects of the disclosure and their embodiments may provide solutions to these or other challenges. In some embodiments, a new framework is introduced, which can be referred to as an Analytic Report Design for Cooperative Control between Correlated Network Functions (“ARD-C3NF”). ARD-C3NF can enable NWDAF to create a novel form of intelligent and efficient collaboration between NFs. NWDAF proceeds with this novel solution when one NFs sends a request for an analytic report and NWDAF detects a critical situation (e.g., a non-predicted urgent degradation in some KPIs). Accordingly, the concerned NF needs to be more capable of improving these KPIs. Using ARD-C3NF, NWDAF exploits attention mechanisms and the graph attention network (“GAT”) to select only relevant NFs to collaborate. After that, it designs adequate analytic reports for these relevant NFs. The design of the analytic reports aims to smartly invite NFs for collaboration, without causing any degradation in the KPIs they are interested in.

According to some embodiments, a method performed by a network node in a communications network is provided. The method includes detecting a triggering event associated with a characteristic of the communications network. The method further includes determining a plurality of network functions (“NFs”), based on operation of each NF of the plurality of NFs impacting the characteristic of the communications network. The method further includes generating a collaborative analytical report for each NF of the plurality of NFs based on their respective impact on the characteristic of the communications network. The method further including transmitting the respective collaborative analytical report to each NF of the plurality of NFs.

According to other embodiments, a method of operating a network node in a communications network is provided. The network node is configured to provide a first network function (“NF”). The method includes receiving a request from a network data analytics function (“NWDAF”) to collaborate with a second NF to control a characteristic of the communications network. The method further comprises determining whether to collaborate with the second NF. The method further includes determining a control policy in regards to the communications network based on determining whether to collaborate with the second NF. The method further includes implementing) the control policy.

According to other embodiments, a NWDAF, NF, network node, host, system, computer program, computer program product, or non-transitory readable medium is provided to perform at least one of the above methods.

Certain embodiments may provide one or more of the following technical advantages. In some embodiments relevant NFs are selected to collaborate to avoid performance degradation of the system.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a signal flow diagram of an example of signals communicated to detect a critical event as part of a process to cause relevant network functions (“NFs”) to collaborate in accordance with some embodiments;

FIG. 3 is a signal flow diagram of an example of signals communicated to estimate a reward as part of a process to cause relevant NFs to collaborate in accordance with some embodiments;

FIG. 4 is a block diagram of an example of operations to cause relevant NFs to collaborate in accordance with some embodiments;

FIG. 5 is a diagram of an example of a two-stage attention mechanism to select relevant NFs for collaboration in accordance with some embodiments;

FIG. 6 is a block diagram illustrating an example of estimating a reward as part of a process to cause relevant NFs to collaborate in accordance with some embodiments;

FIG. 7 is a pair of graphs illustrating an example of reward variation based on the received analytic reports in accordance with some embodiments;

FIG. 8 is a flow chart illustrating an example of operations to perform analytic report transmission in accordance with some embodiments;

FIG. 9 is a signal flow diagram illustrating an example of signals communicated to perform analytic report transmission in accordance with some embodiments;

FIG. 10 is a flow chart illustrating an example of operations performed by a network node configured to provide a network data analytics function (“NWDAF”) in accordance with some embodiments;

FIG. 11 is a flow chart illustrating an example of operations performed by a network node configured to provide a NF in accordance with some embodiments;

FIG. 12 is a block diagram of a communication system in accordance with some embodiments;

FIG. 13 is a block diagram of a user equipment in accordance with some embodiments;

FIG. 14 is a block diagram of a network node in accordance with some embodiments;

FIG. 15 is a block diagram of a host, which may be an embodiment of the host of FIG. 12, in accordance with some embodiments;

FIG. 16 is a block diagram of a virtualization environment in accordance with some embodiments; and

FIG. 17 shows a communication diagram of a host communicating via a network node with a user equipment over a partially wireless connection in accordance with some embodiments.

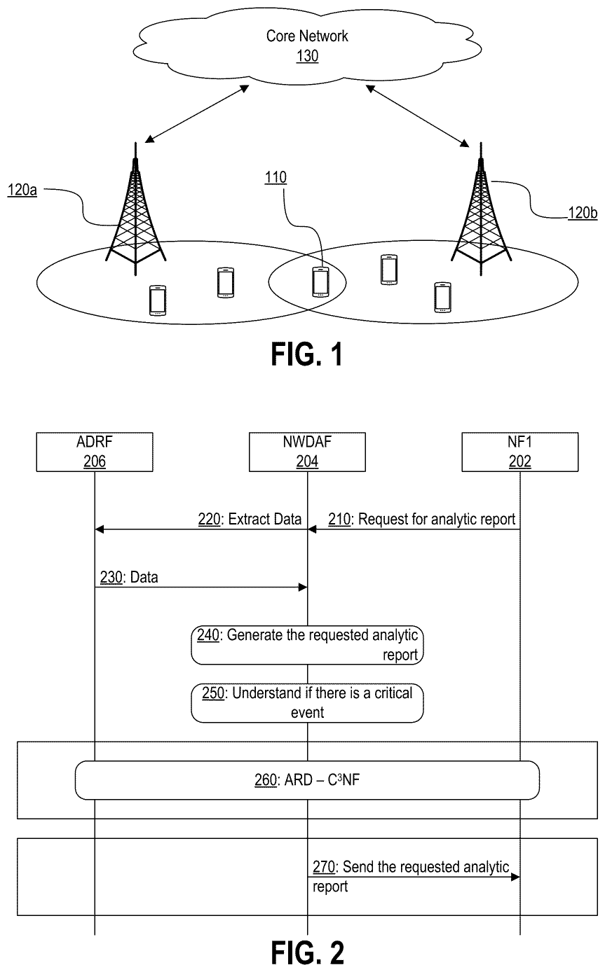

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

There currently exist certain challenges. Many network functions (“NFs”) impact non-disjoint sets of key performance indicators (“KPIs”). When one NF requests the network data analytics function (“NWDAF”) for an analytic report, the NF's objective can be to understand specific KPIs' current/future states. After that, NF can proceed with actions to improve the state of these KPIs. In theory, NFs can always reach their objective regarding improving the KPIs they are interested in. However, in a real scenario, some NFs may not always be capable by themselves of realizing their objectives and improving the KPIs. For example, NFs might face difficulties reaching their goals in response to a novel, critical, and/or unpredictably harsh condition appears.

It may be possible for some NFs to collaborate and help each other by changing their policy and the way they act with the system. Providing the NFs the opportunity to collaborate and help one NF in a critical situation to improve its performance metric. However, it is unclear how to determine the relationship between NFs and whether there is an interaction between them and the importance of this interaction. In some examples, an interaction between two NFs exists when the action of one NFs impacts the KPIs that the second NF wants to improve. In additional or alternative examples, collaborating NFs should not deteriorate their performance metrics. In additional or alternative examples, only relevant NFs should be involved in the collaboration process.

In some embodiments, an Analytic Report Design for Cooperative Control between Correlated Network Functions (“ARD-C³NF”) is provided to: 1) Select relevant NFs for collaboration; 2) Design analytic reports for collaborative control of the relevant NFs; and 3) Transmit the analytic reports to the relevant NFs.

In some examples, to select relevant NFs for collaboration, a new model is provided based on a two-stage attention model combined with a graph attention network (“GAT”) to enable NWDAF to detect relevant NFs for collaboration with the NF in the critical situation.

In additional or alternative examples, to analytic reports are designed based on an optimization problem to design new analytic reports for relevant NFs to collaborate. Analytic reports can be designed to maintain the performance metric of the concerned NFs.

In additional or alternative examples, once the new analytic reports are designed, NWDAF can proceed to send every selected NF the new form of the analytic reports with the requested ones. Therefore, every NF can receive two analytic reports: the default analytic report and the newly designed analytic report for collaboration. If a NF accepts being involved in the collaboration process, it will use the novel designed analytic report (e.g., it will modify its behavior to avoid the predicted performance degradation). Otherwise, it will proceed with the default behavior using the default analytic report.

In some embodiments, ARD-C³NF is executed when NWDAF detects a critical event in the network. FIG. 2 illustrates an example of a signal process for detecting and responding to a critical event in the network. At block 210, an NF 202 sends a request for analytic reports to the NWDAF 204. At blocks 220 and 230, the NWDAF 204 will extract the necessary data from the analytics data repository function (“ADRF”) 206. At block 240, the NWDAF 204 uses different machine learning (“ML”) solutions to generate the required analytic report. At block 250, based on the generated report, the NWDAF 204 can understand the eventual future variation (e.g., degradation or improvement), in some KPIs. Thus, the degradation in the KPIs is critical when it is urgent and related to different valuable resources like the ultra-reliable low latency communication (“URLLC”) traffic delay. At block 260, if the NWDAF 204 detects the critical report, the ARD-C³NF is executed to coordinate collaboration of relevant NFs.

In additional or alternative embodiments, it is assumed that using historical requests for analytic reports and the variation in the system's state (e.g., set of KPIs), the NWDAF can know the KPI every NF wants to improve and/or can impact (at least after each NF has made an action).

In additional or alternative embodiments, it is assumed that some NFs are subscribed to the NWDAF to receive an event-based notification and some NFs are subscribed to the NWDAF to receive periodic notification.

In additional or alternative embodiments, it is assumed that some NFs will agree to collaborate and that some NFs will refuse to collaborate. The NWDAF can know the category of every NFs.

In additional or alternative embodiments, the existing NFs are subscribed to the NWDAF and accept to receive analytic reports proactively (e.g., when a critical event is detected), without sending a request to NWDAF.

In additional or alternative embodiments, the NWDAF knows the request time distribution of NFs subscribed to receive periodic notifications. Thus, the NWDAF can know when every NF will send a request for analytic reports. For example, based on the previous requests from NFs, NWDAF can determine if one NF will submit a request every minute.

In additional or alternative embodiments, once every NF receives an analytic report and interacts with its surrounding environment, it sends feedback to the NWDAF. This feedback indicates the users' satisfaction in terms of improving the KPIs, it wants to enhance.

In additional or alternative embodiments, based on the satisfaction feedback, the NWDAF's observation of the surrounding environment, and the analytic report sent to every NF, the NWDAF can estimate if one NF is able to improve some KPI based on the generated analytic reports. As a result, it can also know if there is a critical event that needs to invite NFs to collaborate (e.g., when executing ARD-C³NF).

A system model is described below. Let F={f₁, . . . , fₙ}, be the set of n NFs subscribed to one NWDAF. For simplification purposes, it can be assumed that the time axis is divided into different equal time slots. t is the time slot starting at time t.

In some embodiments, two types of analytic reports, lᵢ(t) and [symbol] (t), are generated. lᵢ(t) is the default requested analytic report by fᵢ at time t. [symbol] (t) is the novel analytic report that will be designed once a critical event is detected and the fᵢ is invited for collaboration at t. Thus, when executing ARD-C³NF, if fᵢ is selected for collaboration, it can receive both lᵢ(t) and [symbol] (t). When fᵢ receives analytic reports (e.g., [symbol] (t) and/or lᵢ(t)), the NWDAF can observe the variation of KPIs. After that, it can calculate [symbol] (t), an estimation of the fᵢ's reward, rᵢ(t). rᵢ(t) is the objective function that fᵢ wants to improve.

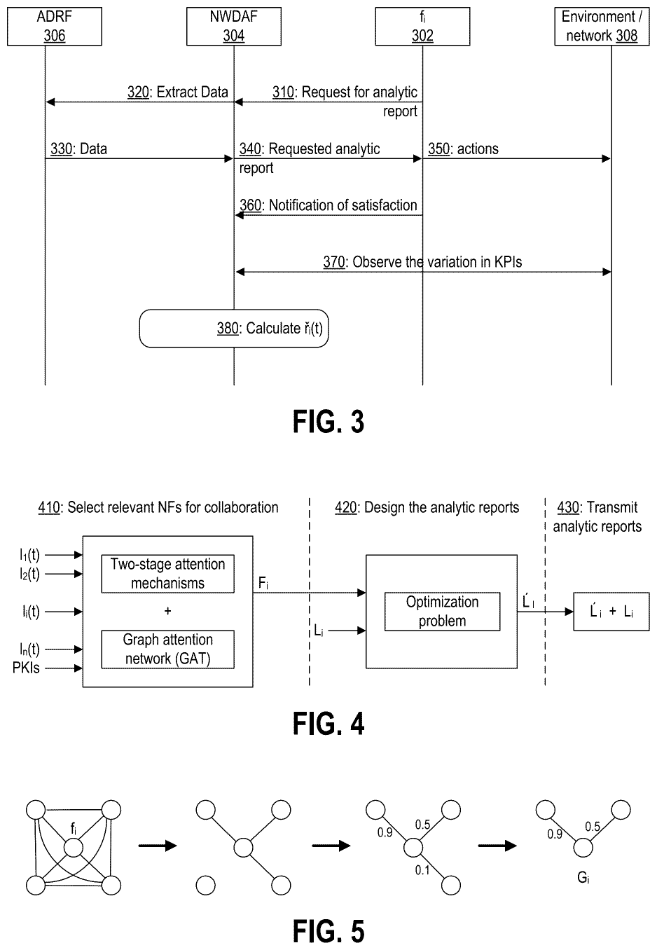

FIG. 3 illustrates an example of a process for estimating the fᵢ's reward, rᵢ(t). At block 310, fᵢ 302 transmits a request for an analytic report to the NWDAF 304. At block 320 and 330, the NWDAF 304 requests and receives data from the ADRF 306. At block 340, the NWDAF 304 transmits the requested analytic report to the fᵢ 302. At block 350, fᵢ 302 performs actions regarding the environment/network 308 based on the analytic report. At block 360, fᵢ 302 transmits a notification of satisfaction to the NWDAF 304 indicating a satisfaction level (e.g., a user QoS) associated with the actions. At block 370, NWDAF 304 observes the variations in the KPIs. At block 380, the NWDAF 304 calculates rᵢ(t) based on the analytic report, the notification of satisfaction, and the variations in KPIs.

FIG. 4 illustrates an example of an ARD-C³NF process divided into three stages. At stage 410, the relevant NFs are selected for collaboration. The NWDAF determines the set of relevant NFs that can collaborate. In some examples, a two-stage attention mechanism is used followed by the graph attention network to learn how much one NF's (fⱼ) collaboration and actions to change some KPIs can help improve the KPIs that fᵢ is interested in (fᵢ in the critical situation). Accordingly, only relevant NFs will be involved in the collaboration process. We denote by

$${F}_{i}^{*} ,$$

the set of relevant NFs to collaborate with fᵢ.

At stage 420, analytic reports are designed for collaborative control of the relevant NFs. In this example, the analytic reports for the selected NFs,

$${F}_{i}^{*} ,$$

are designed. An objective of ARD-C³NF is to avoid the predicted urgent degradation in the KPIs. To this end, the set

$${F}_{i}^{*}$$

should act in away to achieve this objective. It can be assumed that the key element to manage the selected NFs behavior is the received analytic reports. Thus, for every selected relevant NF,

$${f}_{j} ∈ {F}_{i}^{*} ,$$

NWDAF will generate an analytic report denoted as [symbol] . When using [symbol] to decide the action, fⱼ will select the action that enhance the KPIs that are predicted to degrade, i.e., the reward rᵢ(t) of fᵢ.

At stage 430, the analytic reports are transmitted to the relevant NFs. Here, once the new analytic reports are designed, NWDAF transmits them to the different NFs,

$${F}_{i}^{*}$$

Relevant NF selection for collaboration is described below. As depicted in FIG. 5, the NWDAF determines a sub-graph Gᵢ related to fᵢ where only relevant NFs that might impact the KPIs that fᵢ is interested in are involved. To do so, the set of present NFs, F={f₁, . . . , fₙ} is modeled as a graph. The vertices are the links between the NFs. In the beginning, links exist between every pair of edges. First, hard attention can be used to cut the unrelated edges. Then, soft attention can be used to learn the important weight of the edges. The two-stage attention, hard attention and soft attention reduce the size of the graph. It learns the joint impact between connected NFs based on the requested analytic reports. All the resulting NFs, denoted as Fᵢ, are connected to fᵢ, i.e., have important weights,

$${w}_{ij} ( {f}_{j} ∈ {F}_{i}^{*} . ) .$$

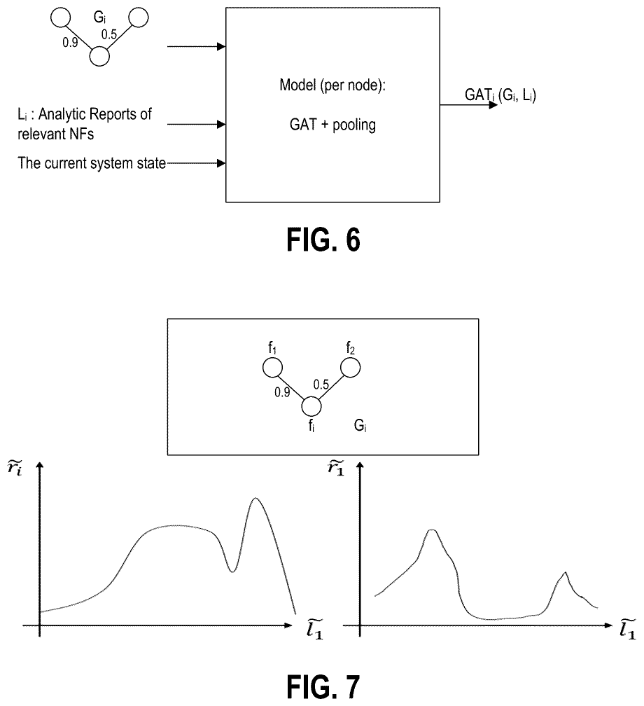

As illustrated in FIG. 6, once the graph Gᵢ is obtained throughout the two-stage attention mechanism, GAT depicted can be used to learn the reward of fᵢ. The loss function of GAT can be modeled as:

$${Loss}_{i} = {‖ {GAT}_{i} ( {G}_{i} , {L}_{i} ) - {\tilde{r}}_{i} ‖}_{2}$$

GATᵢ(Gᵢ, Lᵢ) can be the learned reward of fᵢ. Accordingly, NWDAF compares the obtained reward to its local fᵢ's estimated reward, i.e., \tilde{r}ᵢ. Lᵢ presents the default analytic reports that can be sent to the set of Gᵢ's edges.

In some embodiments, if fᵢ accepts to reveal its reward rᵢ(t), then \tilde{r}ᵢ can be replaced by rᵢ to calculate the loss, Lossᵢ.

In additional or alternative embodiments, if the reward is difficult to observe and estimate, this loss can be replaced by an auto-encoder approach where a decoder model would be used to reproduce the reports Li, or the system state. After this, only the graph encoding given by the attention weights may be used.

Design of the analytic reports is described below. FIG. 7 illustrates the graph Gᵢ composed of fᵢ and the set of NFs, f₁ and f₂, to collaborate. To enable collaboration and avoid the predicted degradation in the KPIs that fᵢ is interested in, the behaviors of f₁ and f₂ may be changed. Generally, every NF makes actions to interact with the surrounding system (e.g., set of KPIs), based on received analytic reports. Thus, the objective here is to design new analytic reports to be sent to the set Fᵢ, i.e., Fᵢ={fᵢ, f₁, f₂} in FIG. 7, in order to improve the reward of the concerned NF [symbol] ∀j∈Fᵢ, [symbol] is designed as a novel form of the analytic report lⱼ. As depicted in FIG. 7, since f₁ is a vertex of the graph Gᵢ. It will be invited for collaboration. Thus, its designed analytic report [symbol] impact the action's selection of f₁. Thus, it will impact both its reward f₁ and fᵢ.

A NWDAF may have a well-defined function, g, to make the transition from lᵢ to \tilde{l}ⱼ:

$$g : {l}_{j} \to \tilde{{l}_{J}} , ∀ j ∈ [ 1 , … , n ]$$

The following optimization problem can describe an algorithm used to design the novel analytic reports:

$${max}_{\tilde{{L}_{1}}} {GAT}_{i} ( {G}_{i} , \tilde{{L}_{1}} ) \qquad ( 1 )$$

$$s . t . {GAT}_{j} ( {G}_{j} , \tilde{{L}_{J}} ) > {λ}_{j} , ∀ j ∈ {F}_{i}^{*} . \qquad ( 2 )$$

$$s . t . \vert {l}_{j} - \tilde{{l}_{J}} \vert < ε , ∀ j ∈ {F}_{i}^{*} . \qquad ( 3 )$$

In this optimization problem, the objective function aims to determine the set of analytic reports [symbol] that maximizes learned reward [symbol] the reward of fᵢ that NWDAF estimates (fᵢ is in a critical situation). Constraint (2) aims to keep the different collaborative NFs with fᵢ satisfied and to not deteriorate their associated rewards. Constraint (3) focuses on the quality of the designed analytic reports, i.e., keep the distance between the default analytic report and the designed one less than a threshold ε.

In some examples, an urgent increase can arise in response to a predicted delay of the URLLC traffic. This critical event can be detected when a NWDAF receives a request from fᵢ responsible of the traffic scheduling. In this case, NWDAF can modify the analytic report to be sent to fⱼ, the NF responsible of the PRB allocation per slice. Therefore, NWDAF can decrease the real statistic related to non-prioritized traffic, thereby fⱼ will reduce the PRB allocated to this traffic and prioritize URLLC traffic.

Analytic report transmissions are described below. Once the new analytic reports are designed Ĩⱼ, j∈F*ᵢ, NWDAF sends to all NFs involved in the collaboration two analytic reports: Ĩⱼ and lⱼ,

$$∀ j ∈ {F}_{i}^{*} .$$

Then, fⱼ can accept the collaboration and behave based on the modified analytic report \tilde{l}ⱼ. Or, it can reject the collaboration and use the true requested reports lⱼ to make actions.

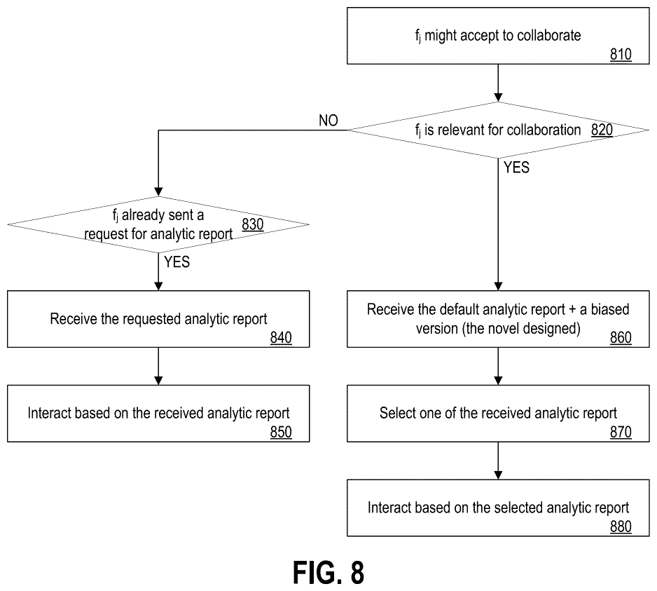

FIG. 8 illustrates an example of an analytic report transmission between NWDAF and the NFs once one NF in a critical situation is detected. At block 810, a NWDAF determines that fⱼ may agree to collaborate. At block 820, the NWDAF determines whether the is fⱼ relevant for collaboration. If not, at block 830, the NWDAF determines whether the fⱼ already sent a request for an analytic report. If yes, then at block 840 the NF will receive the requested analytic report and at block 850, the NF will interact with the network based on the received analytic report. If, at block 830, the NWDAF determines that the fⱼ did not already send a request for an analytic report, the NWDAF may not transmit anything to the fⱼ. If, at block 820, the NWDAF determines the fⱼ is relevant for collaboration, then at block 860, the NF will receive the default analytic report and a biased version (the collaboration analytic report). At block 870, the NF will select one of the received analytical reports and, at block 880, the NF will interact based on the selected analytic report.

As depicted in FIG. 8, the default analytic report is the default answer to one NF when it sends a request for an analytic report. Accordingly, as shown in FIG. 8, NFs that are not selected as relevant will receive their default analytic report if they already sent a request for analytic report. Overwise, they will not receive anything.

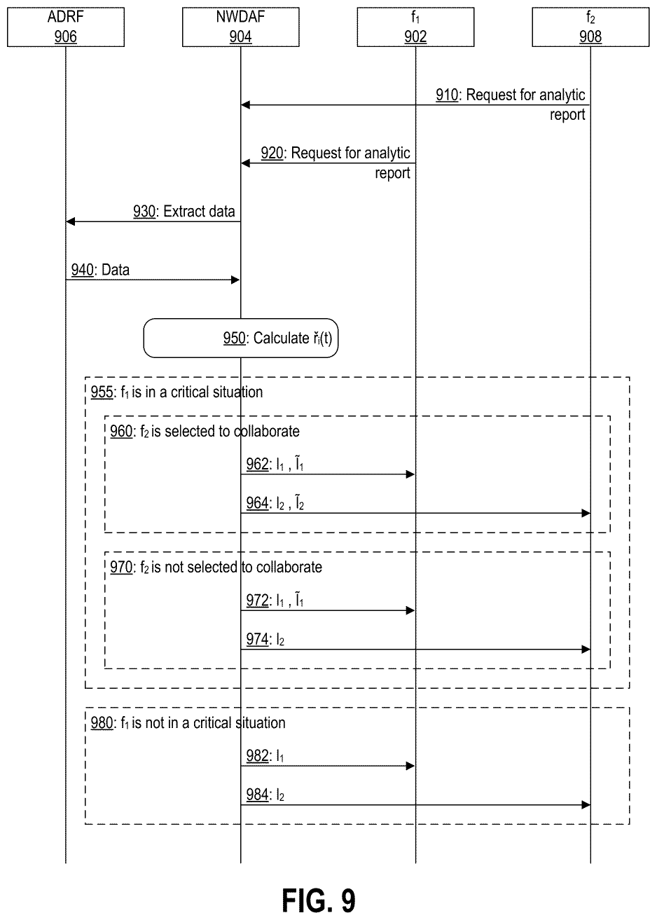

FIG. 9 illustrates an example of signals communicated as part of the analytic reports transmission according to some embodiments. At block 910, f₂ 908 transmits a request for an analytic report to the NWDAF 904. At block 920, f₁ 902 transmits a request for an analytic report to the NWDAF 904. At blocks 930 and 940, the NWDAF 904 obtains data from the ADRF 906. At block 950, the NWDAF 904 calculates the estimated reward, řᵢ(t).

In some examples, as in block 955, f₁ 902 is determined to be in a critical situation. In additional examples, as in block 960, f₂ 908 is selected to collaborate. At block 962, the NWDAF 904 transmits l₁, \tilde{l}₁ to f₁ 902. At block 964, the NWDAF 904 transmits l₂, \tilde{l}₂ to f₂ 908. In alternative examples, as in block 970, f₂ 908 is not selected to collaborate. At block 972, the NWDAF 904 transmits l₁, \tilde{l}₁ to f₁ 902. At block 974, the NWDAF 904 transmits l₂ to f₂ 908.

In alternative examples, as in block 980, f₁ 902 is determined to not be in a critical situation. At block 982, the NWDAF 904 transmits l₁ to f₁ 902. At block 984, the NWDAF 904 transmits l₂ to f₂ 908.

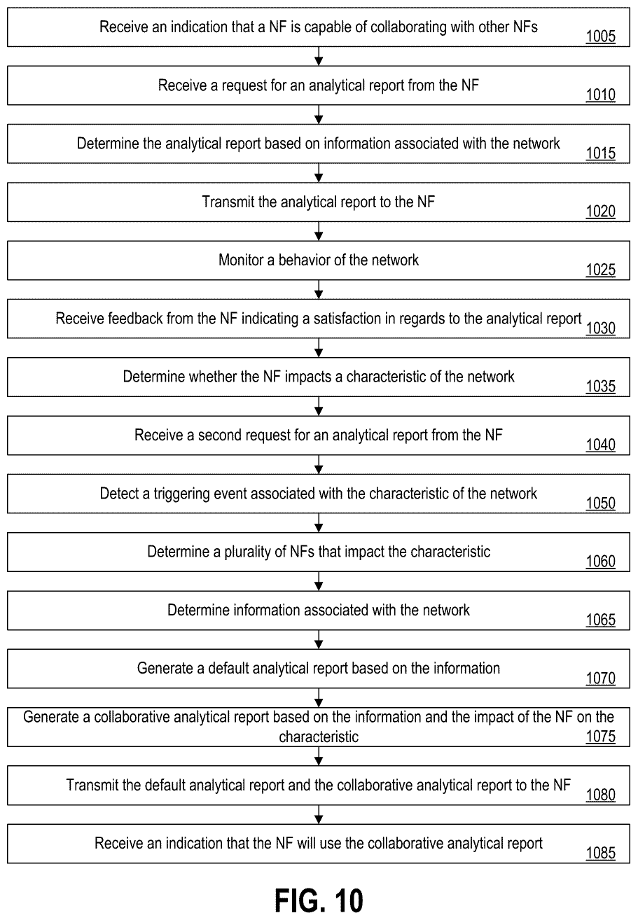

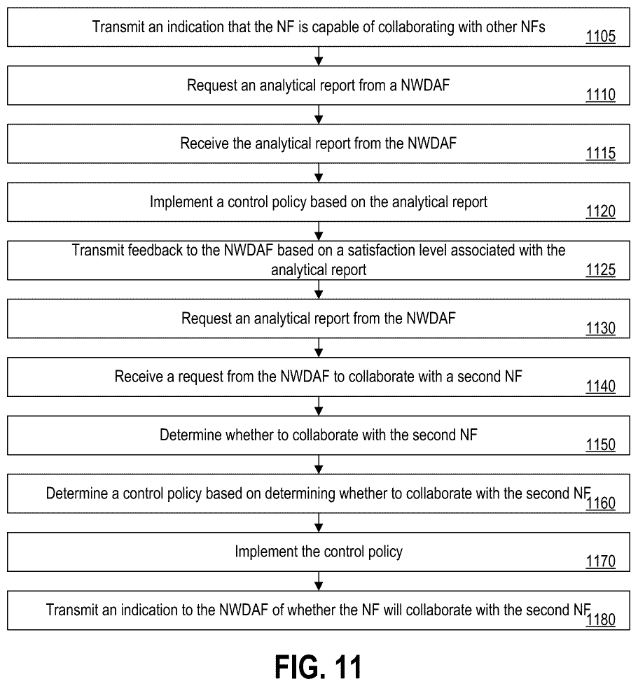

Operations of the RAN node 1400 (implemented using the structure of FIG. 14) will now be discussed with reference to the flow charts of FIGS. 10-11 according to some embodiments of inventive concepts. For example, modules may be stored in memory 1404 of FIG. 14, and these modules may provide instructions so that when the instructions of a module are executed by respective RAN node processing circuitry 1320, RAN node 1400 performs respective operations of the flow charts.

FIG. 10 illustrates an example of operations performed by a network node (e.g., a network node configured to provide a NWDAF) in accordance with some embodiments. In some embodiments, the network node is further configured to provide one or more NFs.

At block 1005, processing circuitry 1402 receives, via communication interface 1406, an indication that a NF is capable of collaborating with other NFs.

At block 1010, processing circuitry 1402 receives, via communication interface 1406, a request for an analytical report from the NF.

At block 1015, processing circuitry 1402 determines the analytical report based on information associated with the network.

At block 1020, processing circuitry 1402 transmits, via communication interface 1406, the analytical report to the NF.

At block 1025, processing circuitry 1402 monitors a behavior of the network.

At block 1030, processing circuitry 1402 receives, via communication interface 1406, feedback from the NF indicating a satisfaction level in regards to the analytical report.

At block 1035, processing circuitry 1402 determines whether the NF impacts a characteristic of the network. In some embodiments, the characteristic includes a key performance indicator (“KPI”).

At block 1040, processing circuitry 1402 receives a second request for an analytical report from the NF.

At block 1050, processing circuitry 1402 detects a triggering event associated with the characteristic of the network. In some embodiments, detecting the triggering event includes at least one of: determining that the characteristic has degraded beyond a threshold level; and determining that the characteristic is degrading at a rate above a threshold rate.

At block 1060, processing circuitry 1402 determines a plurality of NFs that impact the characteristic. In some embodiments, determining the plurality of NFs includes determining the plurality of NFs based on at least one of: the behavior of the communications network, the analytical report, and the satisfaction level.

At block 1065, processing circuitry 1402 determines information associated with the network.

At block 1070, processing circuitry 1402 generates a collaborative analytical report based on the information and the impact of the NF on the characteristic. In some embodiments, generating the collaborative analytical report includes generating the collaborative analytical report to improve the characteristic of the communications network while keeping the satisfaction level above a threshold level.

At block 1080, processing circuitry 1402 transmits, via communication interface 1406, the default analytical report and the collaborative analytical report to the NF.

At block 1090, processing circuitry 1402 receives, via communication interface 1406, an indication that the NF will use the collaborative analytical report.

FIG. 11 illustrates an example of operations performed by a network node configured to provide a NF in accordance with some embodiments. In some embodiments, the network node is further configured to provide a NWDAF.

At block 1105, processing circuitry 1402 transmits, via communication interface 1406, an indication that the NF is capable of collaborating with other NFs.

At block 1110, processing circuitry 1402 requests, via communication interface 1406, an analytical report from a NWDAF.

At block 1115, processing circuitry 1402 receives, via communication interface 1406, the analytical report from the NWDAF.

At block 1120, processing circuitry 1402 implements a control policy based on the analytical report.

At block 1125, processing circuitry 1402 transmits, via communication interface 1406, feedback to the NWDAF based on a satisfaction level associated with the analytical report.

At block 1130, processing circuitry 1402 requests, via communication interface 1406, an analytical report from the NWDAF.

At block 1140, processing circuitry 1402 receives a request from the NWDAF to collaborate with a second NF. In some embodiments, receiving the request from the NWDAF includes receiving the request from the NWDAF in response to requesting the analytical report from the NWDAF.

At block 1150, processing circuitry 1402 determines whether to collaborate with the second NF. In some embodiments, determining whether to collaborate with the second NF includes determining whether collaborating with the second NF will reduce user experience below a threshold level.

At block 1160, processing circuitry 1402 determines a control policy based on determining whether to collaborate with the second NF. In some embodiments, receiving the request from the NWDAF to collaborate with the second NF includes: receiving a default analytical report including information associated with the communications network; and receiving a collaborative analytical report including a biased-version of the information. Determining whether to collaborate with the second NF includes determining whether to use the default analytical report or the collaborative analytical report. Determining the control policy includes determining the control policy based on the default analytical report or the collaborative analytical report.

At block 1170, processing circuitry 1402 implements the control policy (determined at block 1160).

At block 1180, processing circuitry 1402 transmits, via communication interface 1406, an indication to the NWDAF of whether the NF will collaborate with the second NF.

Various operations from the flow charts of FIGS. 10-11 may be optional with respect to some embodiments of network nodes configured to provide NWDAFs and/or NFs and related methods.

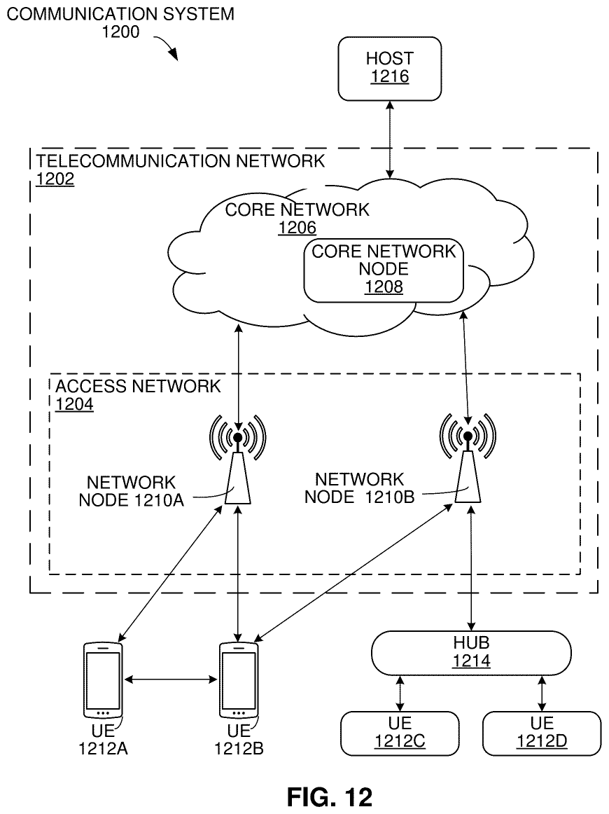

FIG. 12 shows an example of a communication system 1200 in accordance with some embodiments.

In the example, the communication system 1200 includes a telecommunication network 1202 that includes an access network 1204, such as a radio access network (RAN), and a core network 1206, which includes one or more core network nodes 1208. The access network 1204 includes one or more access network nodes, such as network nodes 1210a and 1210b (one or more of which may be generally referred to as network nodes 1210), or any other similar 3rd Generation Partnership Project (3GPP) access node or non-3GPP access point. Moreover, as will be appreciated by those of skill in the art, the network nodes 1210 are not necessarily limited to an implementation in which a radio portion and a baseband portion are supplied and integrated by a single vendor. Thus, it will be understood that the network nodes 1210 may include disaggregated implementations or portions thereof. For example, in some embodiments, the telecommunication network 1202 includes one or more Open-RAN (ORAN) network nodes. An ORAN network node is a node in the telecommunication network 1202 that supports an ORAN specification (e.g., a specification published by the O-RAN Alliance, or any similar organization) and may operate alone or together with other nodes to implement one or more functionalities of any node in the telecommunication network 1202, including one or more network nodes 1210 and/or core network nodes 1208.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 1210 facilitate direct or indirect connection of user equipment (UE), such as by connecting wireless devices 1212a, 1212b, 1212c, and 1212d (one or more of which may be generally referred to as UEs 1212) to the core network 1206 over one or more wireless connections. The network nodes 1210 facilitate direct or indirect connection of user equipment (UE), such as by connecting UEs 1212a, 1212b, 1212c, and 1212d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

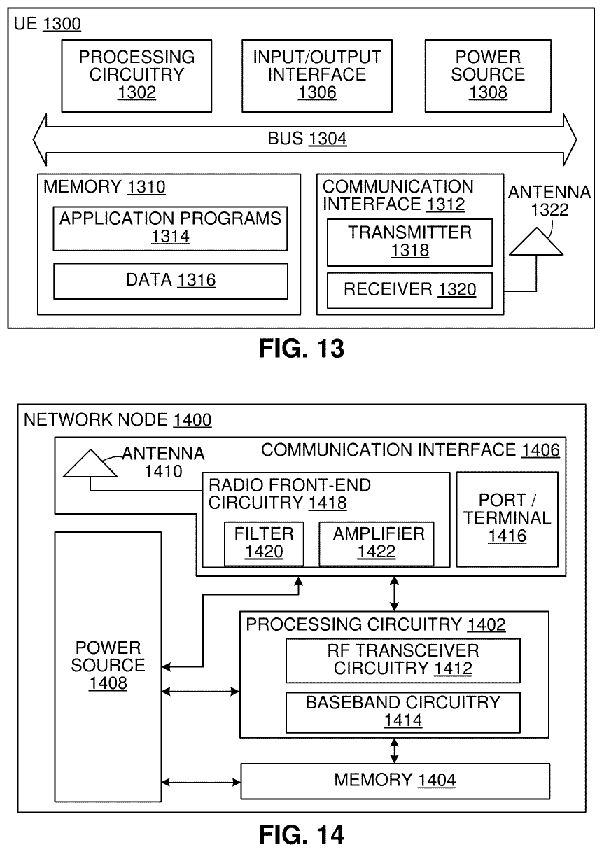

FIG. 13 shows a UE 1300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1300 includes processing circuitry 1302 that is operatively coupled via a bus 1304 to an input/output interface 1306, a power source 1308, a memory 1310, a communication interface 1312, and/or any other component, or any combination thereof. Certain UEs may utilize all or a subset of the components shown in FIG. 13. The level of integration between the components may vary from one UE to another UE. Further, certain UEs may contain multiple instances of a component, such as multiple processors, memories, transceivers, transmitters, receivers, etc.

The processing circuitry 1302 is configured to process instructions and data and may be configured to implement any sequential state machine operative to execute instructions stored as machine-readable computer programs in the memory 1310. The processing circuitry 1302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1302 may include multiple central processing units (CPUs).

In the example, the input/output interface 1306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1308 is structured as a battery or battery pack. Other types of power sources, such as an external power source (e.g., an electricity outlet), photovoltaic device, or power cell, may be used. The power source 1308 may further include power circuitry for delivering power from the power source 1308 itself, and/or an external power source, to the various parts of the UE 1300 via input circuitry or an interface such as an electrical power cable. Delivering power may be, for example, for charging of the power source 1308. Power circuitry may perform any formatting, converting, or other modification to the power from the power source 1308 to make the power suitable for the respective components of the UE 1300 to which power is supplied.

The memory 1310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1310 includes one or more application programs 1314, such as an operating system, web browser application, a widget, gadget engine, or other application, and corresponding data 1316. The memory 1310 may store, for use by the UE 1300, any of a variety of various operating systems or combinations of operating systems.

The memory 1310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1310 may allow the UE 1300 to access instructions, application programs and the like, stored on transitory or non-transitory memory media, to off-load data, or to upload data. An article of manufacture, such as one utilizing a communication system may be tangibly embodied as or in the memory 1310, which may be or comprise a device-readable storage medium.

The processing circuitry 1302 may be configured to communicate with an access network or other network using the communication interface 1312. The communication interface 1312 may comprise one or more communication subsystems and may include or be communicatively coupled to an antenna 1322. The communication interface 1312 may include one or more transceivers used to communicate, such as by communicating with one or more remote transceivers of another device capable of wireless communication (e.g., another UE or a network node in an access network). Each transceiver may include a transmitter 1318 and/or a receiver 1320 appropriate to provide network communications (e.g., optical, electrical, frequency allocations, and so forth). Moreover, the transmitter 1318 and receiver 1320 may be coupled to one or more antennas (e.g., antenna 1322) and may share circuit components, software or firmware, or alternatively be implemented separately.

In the illustrated embodiment, communication functions of the communication interface 1312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1300 shown in FIG. 13.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 14 shows a network node 1400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1400 includes a processing circuitry 1402, a memory 1404, a communication interface 1406, and a power source 1408. The network node 1400 may be composed of multiple physically separate components (e.g., a NodeB component and a RNC component, or a BTS component and a BSC component, etc.), which may each have their own respective components. In certain scenarios in which the network node 1400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1400 may be configured to support multiple radio access technologies (RATs). In such embodiments, some components may be duplicated (e.g., separate memory 1404 for different RATs) and some components may be reused (e.g., a same antenna 1410 may be shared by different RATs). The network node 1400 may also include multiple sets of the various illustrated components for different wireless technologies integrated into network node 1400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1400.

The processing circuitry 1402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1400 components, such as the memory 1404, to provide network node 1400 functionality.

In some embodiments, the processing circuitry 1402 includes a system on a chip (SOC). In some embodiments, the processing circuitry 1402 includes one or more of radio frequency (RF) transceiver circuitry 1412 and baseband processing circuitry 1414. In some embodiments, the radio frequency (RF) transceiver circuitry 1412 and the baseband processing circuitry 1414 may be on separate chips (or sets of chips), boards, or units, such as radio units and digital units. In alternative embodiments, part or all of RF transceiver circuitry 1412 and baseband processing circuitry 1414 may be on the same chip or set of chips, boards, or units.

The memory 1404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD), and/or any other volatile or non-volatile, non-transitory device-readable and/or computer-executable memory devices that store information, data, and/or instructions that may be used by the processing circuitry 1402. The memory 1404 may store any suitable instructions, data, or information, including a computer program, software, an application including one or more of logic, rules, code, tables, and/or other instructions capable of being executed by the processing circuitry 1402 and utilized by the network node 1400. The memory 1404 may be used to store any calculations made by the processing circuitry 1402 and/or any data received via the communication interface 1406. In some embodiments, the processing circuitry 1402 and memory 1404 is integrated.

The communication interface 1406 is used in wired or wireless communication of signaling and/or data between a network node, access network, and/or UE. As illustrated, the communication interface 1406 comprises port(s)/terminal(s) 1416 to send and receive data, for example to and from a network over a wired connection. The communication interface 1406 also includes radio front-end circuitry 1418 that may be coupled to, or in certain embodiments a part of, the antenna 1410. Radio front-end circuitry 1418 comprises filters 1420 and amplifiers 1422. The radio front-end circuitry 1418 may be connected to an antenna 1410 and processing circuitry 1402. The radio front-end circuitry may be configured to condition signals communicated between antenna 1410 and processing circuitry 1402. The radio front-end circuitry 1418 may receive digital data that is to be sent out to other network nodes or UEs via a wireless connection. The radio front-end circuitry 1418 may convert the digital data into a radio signal having the appropriate channel and bandwidth parameters using a combination of filters 1420 and/or amplifiers 1422. The radio signal may then be transmitted via the antenna 1410. Similarly, when receiving data, the antenna 1410 may collect radio signals which are then converted into digital data by the radio front-end circuitry 1418. The digital data may be passed to the processing circuitry 1402. In other embodiments, the communication interface may comprise different components and/or different combinations of components.

In certain alternative embodiments, the network node 1400 does not include separate radio front-end circuitry 1418, instead, the processing circuitry 1402 includes radio front-end circuitry and is connected to the antenna 1410. Similarly, in some embodiments, all or some of the RF transceiver circuitry 1412 is part of the communication interface 1406. In still other embodiments, the communication interface 1406 includes one or more ports or terminals 1416, the radio front-end circuitry 1418, and the RF transceiver circuitry 1412, as part of a radio unit (not shown), and the communication interface 1406 communicates with the baseband processing circuitry 1414, which is part of a digital unit (not shown).

The antenna 1410 may include one or more antennas, or antenna arrays, configured to send and/or receive wireless signals. The antenna 1410 may be coupled to the radio front-end circuitry 1418 and may be any type of antenna capable of transmitting and receiving data and/or signals wirelessly. In certain embodiments, the antenna 1410 is separate from the network node 1400 and connectable to the network node 1400 through an interface or port.

The antenna 1410, communication interface 1406, and/or the processing circuitry 1402 may be configured to perform any receiving operations and/or certain obtaining operations described herein as being performed by the network node. Any information, data and/or signals may be received from a UE, another network node and/or any other network equipment. Similarly, the antenna 1410, the communication interface 1406, and/or the processing circuitry 1402 may be configured to perform any transmitting operations described herein as being performed by the network node. Any information, data and/or signals may be transmitted to a UE, another network node and/or any other network equipment.

The power source 1408 provides power to the various components of network node 1400 in a form suitable for the respective components (e.g., at a voltage and current level needed for each respective component).

The power source 1408 may further comprise, or be coupled to, power management circuitry to supply the components of the network node 1400 with power for performing the functionality described herein. For example, the network node 1400 may be connectable to an external power source (e.g., the power grid, an electricity outlet) via an input circuitry or interface such as an electrical cable, whereby the external power source supplies power to power circuitry of the power source 1408. As a further example, the power source 1408 may comprise a source of power in the form of a battery or battery pack which is connected to, or integrated in, power circuitry. The battery may provide backup power should the external power source fail.

Embodiments of the network node 1400 may include additional components beyond those shown in FIG. 14 for providing certain aspects of the network node's functionality, including any of the functionality described herein and/or any functionality necessary to support the subject matter described herein. For example, the network node 1400 may include user interface equipment to allow input of information into the network node 1400 and to allow output of information from the network node 1400. This may allow a user to perform diagnostic, maintenance, repair, and other administrative functions for the network node 1400.

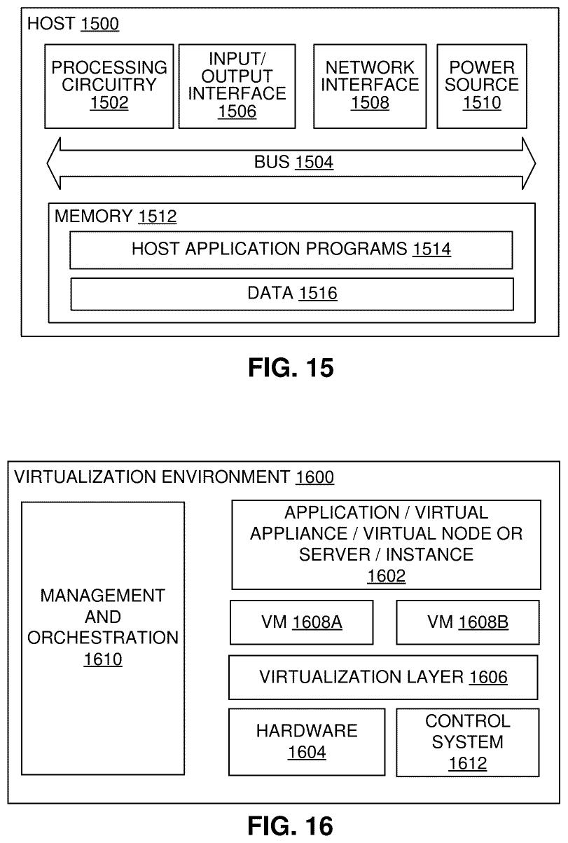

FIG. 15 is a block diagram of a host 1500, which may be an embodiment of the host 1216 of FIG. 12, in accordance with various aspects described herein. As used herein, the host 1500 may be or comprise various combinations hardware and/or software, including a standalone server, a blade server, a cloud-implemented server, a distributed server, a virtual machine, container, or processing resources in a server farm. The host 1500 may provide one or more services to one or more UEs.

The host 1500 includes processing circuitry 1502 that is operatively coupled via a bus 1504 to an input/output interface 1506, a network interface 1508, a power source 1510, and a memory 1512. Other components may be included in other embodiments. Features of these components may be substantially similar to those described with respect to the devices of previous figures, such as FIGS. 13 and 14, such that the descriptions thereof are generally applicable to the corresponding components of host 1500.

The memory 1512 may include one or more computer programs including one or more host application programs 1514 and data 1516, which may include user data, e.g., data generated by a UE for the host 1500 or data generated by the host 1500 for a UE. Embodiments of the host 1500 may utilize only a subset or all of the components shown. The host application programs 1514 may be implemented in a container-based architecture and may provide support for video codecs (e.g., Versatile Video Coding (WVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1514 may also provide for user authentication and licensing checks and may periodically report health, routes, and content availability to a central node, such as a device in or on the edge of a core network. Accordingly, the host 1500 may select and/or indicate a different host for over-the-top services for a UE. The host application programs 1514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 16 is a block diagram illustrating a virtualization environment 1600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1600 includes components defined by the O-RAN Alliance, such as an O-Cloud environment orchestrated by a Service Management and Orchestration Framework via an O-2 interface.

Applications 1602 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1604 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1606 (also referred to as hypervisors or virtual machine monitors (VMMs)), provide VMs 1608a and 1608b (one or more of which may be generally referred to as VMs 1608), and/or perform any of the functions, features and/or benefits described in relation with some embodiments described herein. The virtualization layer 1606 may present a virtual operating platform that appears like networking hardware to the VMs 1608.

The VMs 1608 comprise virtual processing, virtual memory, virtual networking or interface and virtual storage, and may be run by a corresponding virtualization layer 1606. Different embodiments of the instance of a virtual appliance 1602 may be implemented on one or more of VMs 1608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1608 may be a software implementation of a physical machine that runs programs as if they were executing on a physical, non-virtualized machine. Each of the VMs 1608, and that part of hardware 1604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1608 on top of the hardware 1604 and corresponds to the application 1602.

Hardware 1604 may be implemented in a standalone network node with generic or specific components. Hardware 1604 may implement some functions via virtualization. Alternatively, hardware 1604 may be part of a larger cluster of hardware (e.g. such as in a data center or CPE) where many hardware nodes work together and are managed via management and orchestration 1610, which, among others, oversees lifecycle management of applications 1602. In some embodiments, hardware 1604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1612 which may alternatively be used for communication between hardware nodes and radio units.

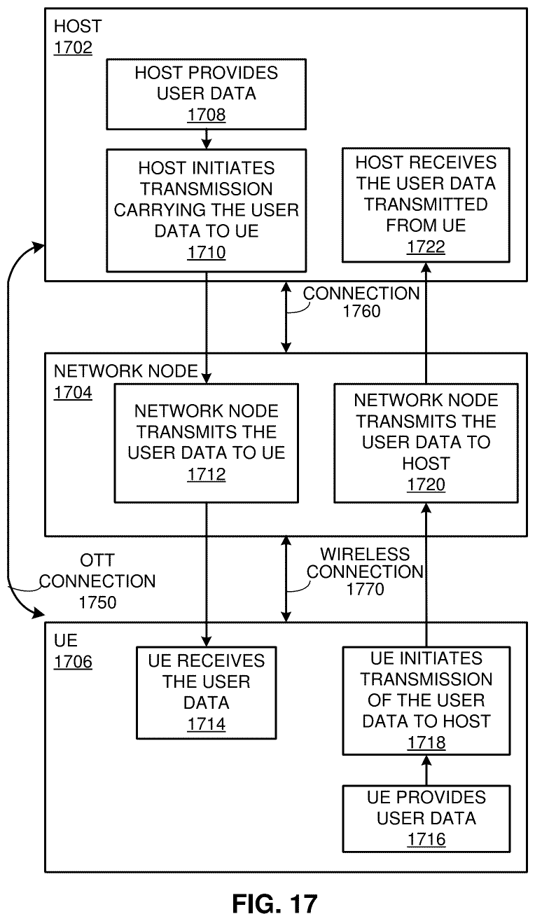

FIG. 17 shows a communication diagram of a host 1702 communicating via a network node 1704 with a UE 1706 over a partially wireless connection in accordance with some embodiments. Example implementations, in accordance with various embodiments, of the UE (such as a UE 1212a of FIG. 12 and/or UE 1300 of FIG. 13), network node (such as network node 1210a of FIG. 12 and/or network node 1400 of FIG. 14), and host (such as host 1216 of FIG. 12 and/or host 1500 of FIG. 15) discussed in the preceding paragraphs will now be described with reference to FIG. 17.

Like host 1500, embodiments of host 1702 include hardware, such as a communication interface, processing circuitry, and memory. The host 1702 also includes software, which is stored in or accessible by the host 1702 and executable by the processing circuitry. The software includes a host application that may be operable to provide a service to a remote user, such as the UE 1706 connecting via an over-the-top (OTT) connection 1750 extending between the UE 1706 and host 1702. In providing the service to the remote user, a host application may provide user data which is transmitted using the OTT connection 1750.

The network node 1704 includes hardware enabling it to communicate with the host 1702 and UE 1706. The connection 1760 may be direct or pass through a core network (like core network 1206 of FIG. 12) and/or one or more other intermediate networks, such as one or more public, private, or hosted networks. For example, an intermediate network may be a backbone network or the Internet.

The UE 1706 includes hardware and software, which is stored in or accessible by UE 1706 and executable by the UE's processing circuitry. The software includes a client application, such as a web browser or operator-specific “app” that may be operable to provide a service to a human or non-human user via UE 1706 with the support of the host 1702. In the host 1702, an executing host application may communicate with the executing client application via the OTT connection 1750 terminating at the UE 1706 and host 1702. In providing the service to the user, the UE's client application may receive request data from the host's host application and provide user data in response to the request data. The OTT connection 1750 may transfer both the request data and the user data. The UE's client application may interact with the user to generate the user data that it provides to the host application through the OTT connection 1750.

The OTT connection 1750 may extend via a connection 1760 between the host 1702 and the network node 1704 and via a wireless connection 1770 between the network node 1704 and the UE 1706 to provide the connection between the host 1702 and the UE 1706. The connection 1760 and wireless connection 1770, over which the OTT connection 1750 may be provided, have been drawn abstractly to illustrate the communication between the host 1702 and the UE 1706 via the network node 1704, without explicit reference to any intermediary devices and the precise routing of messages via these devices.

As an example of transmitting data via the OTT connection 1750, in step 1708, the host 1702 provides user data, which may be performed by executing a host application. In some embodiments, the user data is associated with a particular human user interacting with the UE 1706. In other embodiments, the user data is associated with a UE 1706 that shares data with the host 1702 without explicit human interaction. In step 1710, the host 1702 initiates a transmission carrying the user data towards the UE 1706. The host 1702 may initiate the transmission responsive to a request transmitted by the UE 1706. The request may be caused by human interaction with the UE 1706 or by operation of the client application executing on the UE 1706. The transmission may pass via the network node 1704, in accordance with the teachings of the embodiments described throughout this disclosure. Accordingly, in step 1712, the network node 1704 transmits to the UE 1706 the user data that was carried in the transmission that the host 1702 initiated, in accordance with the teachings of the embodiments described throughout this disclosure. In step 1714, the UE 1706 receives the user data carried in the transmission, which may be performed by a client application executed on the UE 1706 associated with the host application executed by the host 1702.

In some examples, the UE 1706 executes a client application which provides user data to the host 1702. The user data may be provided in reaction or response to the data received from the host 1702. Accordingly, in step 1716, the UE 1706 may provide user data, which may be performed by executing the client application. In providing the user data, the client application may further consider user input received from the user via an input/output interface of the UE 1706. Regardless of the specific manner in which the user data was provided, the UE 1706 initiates, in step 1718, transmission of the user data towards the host 1702 via the network node 1704. In step 1720, in accordance with the teachings of the embodiments described throughout this disclosure, the network node 1704 receives user data from the UE 1706 and initiates transmission of the received user data towards the host 1702. In step 1722, the host 1702 receives the user data carried in the transmission initiated by the UE 1706.

One or more of the various embodiments improve the performance of OTT services provided to the UE 1706 using the OTT connection 1750, in which the wireless connection 1770 forms the last segment. More precisely, the teachings of these embodiments may enable relevant NFs to be selected to collaborate such that they avoid performance degradation of the system.

In an example scenario, factory status information may be collected and analyzed by the host 1702. As another example, the host 1702 may process audio and video data which may have been retrieved from a UE for use in creating maps. As another example, the host 1702 may collect and analyze real-time data to assist in controlling vehicle congestion (e.g., controlling traffic lights). As another example, the host 1702 may store surveillance video uploaded by a UE. As another example, the host 1702 may store or control access to media content such as video, audio, VR or AR which it can broadcast, multicast or unicast to UEs. As other examples, the host 1702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1750 between the host 1702 and UE 1706, in response to variations in the measurement results. The measurement procedure and/or the network functionality for reconfiguring the OTT connection may be implemented in software and hardware of the host 1702 and/or UE 1706. In some embodiments, sensors (not shown) may be deployed in or in association with other devices through which the OTT connection 1750 passes; the sensors may participate in the measurement procedure by supplying values of the monitored quantities exemplified above, or supplying values of other physical quantities from which software may compute or estimate the monitored quantities. The reconfiguring of the OTT connection 1750 may include message format, retransmission settings, preferred routing etc.; the reconfiguring need not directly alter the operation of the network node 1704. Such procedures and functionalities may be known and practiced in the art. In certain embodiments, measurements may involve proprietary UE signaling that facilitates measurements of throughput, propagation times, latency and the like, by the host 1702. The measurements may be implemented in that software causes messages to be transmitted, in particular empty or ‘dummy’ messages, using the OTT connection 1750 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a network node in a communications network, the method comprising:
detecting a triggering event associated with a characteristic of the communications network;
determining a plurality of network functions, NFs, based on operation of each NF of the plurality of NFs impacting the characteristic of the communications network;
generating a collaborative analytical report for each NF of the plurality of NFs based on their respective impact on the characteristic of the communications network; and
transmitting the respective collaborative analytical report to each NF of the plurality of NFs.

2. The method of claim 1, wherein detecting the triggering event comprises at least one of:
determining that the characteristic has degraded beyond a threshold level; and
determining that the characteristic is degrading at a rate above a threshold rate.

3. The method of claim 1, wherein the characteristic comprises a key performance indicator, KPI.

4. The method of claim 1, further comprising:
receiving a request for an analytical report from a first NF,
wherein generating the collaborative analytical report for each NF comprises determining that the first NF is part of the plurality of NFs, and
wherein transmitting the respective collaborative analytical report to each NF comprises, responsive to determining that the first NF is part of the plurality of NFs, transmitting the respective collaborative analytical report to the first NF.

5. The method of claim 1, further comprising:
determining information associated with the communications network; and
generating a default analytical report based on the information,
wherein generating the collaborative analytical report comprises generating the collaborative analytical report for each NF of the plurality of NFs based on their respective impact on the characteristic of the communications network and based on the information, and
wherein transmitting the respective collaborative analytical report comprises transmitting the respective collaborative analytical report and the default report.

6. The method of claim 1, further comprising:
receiving a request for an analytical report from a first NF;
responsive to receiving the request, determining the analytical report based on information associated with the communications network;
transmitting the analytical report to the first NF;
responsive to transmitting the analytical report to the first NF, monitoring a behavior of the communications network;
responsive to transmitting the analytical report to the first NF, receiving feedback from the first NF indicating a satisfaction level in regards to usage of the analytical report; and
determining whether the first NF impacts the characteristic of the communications network based on at least one of: the behavior of the communications network, the analytical report, and the satisfaction level.

7. The method of claim 6, wherein generating the collaborative analytical report comprises generating the collaborative analytical report to improve the characteristic of the communications network while keeping the satisfaction level above a threshold level.

8. The method of claim 6, wherein determining the plurality of NFs comprises determining the plurality of NFs based on at least one of: the behavior of the communications network, the analytical report, the satisfaction level, and an interaction level between different NF behaviors.

9. The method of claim 1, further comprising:
receiving an indication from each NF of the plurality of NFs that each NF is capable of collaborating with other NFs in the plurality of NFs.

10. The method of claim 1, further comprising:
responsive to transmitting the respective collaborative analytical report, receiving an indication that a first NF of the plurality of NFs will use the collaborative analytical report.

11. The method of claim 1, wherein the network node is configured to provide a network data analytics function, NWDAF.

12. A method of operating a network node in a communications network, the network node being configured to provide a first network function, NF, the method comprising:
receiving a request from a network data analytics function, NWDAF, to collaborate with a second NF to control a characteristic of the communications network;
determining whether to collaborate with the second NF;
determining a control policy in regards to the communications network based on determining whether to collaborate with the second NF; and
implementing the control policy.

13. The method of claim 12, wherein receiving the request from the NWDAF to collaborate with the second NF comprises:
receiving a default analytical report including information associated with the communications network; and
receiving a collaborative analytical report including a biased-version of the information,
wherein determining whether to collaborate with the second NF comprises determining whether to use the default analytical report or the collaborative analytical report, and
wherein determining the control policy comprises determining the control policy based on the default analytical report or the collaborative analytical report.

14. The method of claim 12, wherein determining whether to collaborate with the second NF comprises determining whether collaborating with the second NF will reduce user experience below a threshold level.

15. The method of claim 12, wherein the control policy is a second control policy,
the method further comprising:
prior to receiving the request from the NWDAF to collaborate, requesting an analytical report from the NWDAF;
prior to receiving the request from the NWDAF to collaborate, receiving the analytical report from the NWDAF;
prior to receiving the request from the NWDAF to collaborate, implementing a second control policy in regards to the communications network based on the analytical report; and
prior to receiving the request from the NWDAF to collaborate, transmitting feedback to the NWDAF based on a satisfaction level in regards to implementing the second control policy.

16. The method of claim 12, further comprising:
requesting an analytical report from the NWDAF,
wherein receiving the request from the NWDAF comprises receiving the request from the NWDAF in response to requesting the analytical report from the NWDAF.

17. The method of claim 12, further comprising:
transmitting an indication to the NWDAF that the first NF is capable of collaborating with other NFs.

18. The method of claim 12, further comprising:
responsive to determining to collaborate with the second NF, transmitting an indication to the NWDAF that the first NF will collaborate with the second NF.

19. The method of claim 12, wherein the network node is further configured to provide at least one of:
the NWDAF; and
the second NF.

20.-23. (canceled)
